(19) United States
(12) Patent Application Publication
(10) Pub. No.: US 2010/0073494 A1
(43) Pub. Date: Mar. 25, 2010

(54) ELECTRONIC APPARATUS FOR IMPROVING BRIGHTNESS OF DARK IMAGED PICTURE

(75) Inventors: Masayuki Hirose, Kawasaki (JP); Kaoru Chujo, Kawasaki (JP); Kimitaka Murashita, Kawasaki (JP); Masayoshi Shimizu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/629,440

(22) Filed: Dec. 2, 2009

Related U.S. Application Data
(63) Continuation of application No. PCT/JP2007/063042, filed on Jun. 28, 2007.

(51) Int. Cl. H04N 5/228; H04N 9/68

(52) U.S. Cl. 348/208.4; 348/234; 348/E09.053; 348/E05.024

(57) ABSTRACT

An electronic apparatus includes an imager unit, a control unit, a brightness correction determiner unit, and a corrector unit. The imager unit images a picture. The control unit obtains, from the imager unit, data of the imaged picture and an imaging condition applied to the picture. The brightness correction determiner unit compares the obtained imaging condition with a threshold and determines whether or not to correct brightness of the data of the imaged picture. In response to the determination by the determiner unit to correct the brightness, The corrector unit corrects the data of the imaged picture so that the brightness of the imaged picture is increased in accordance with a brightness correction function.

### CROSS-REFERENCE TO RELATED APPLICATION

This application is a U.S. continuation application filed under 35 USC 111(a) claiming benefit under 35 USC 120 and 365(c) of international application PCT/JP2007/63042, filed on Jun. 28, 2007, the entire contents of which are incorporated herein by reference.

### FIELD

A certain aspect of the embodiments discussed herein is related generally to correcting brightness of an imaged picture, and more particularly to processing for correcting brightness of a dark imaged picture which may be imaged by a digital imager module in a low illuminance or illumination environment.

### BACKGROUND

An electronic apparatus having a digital camera may adjusts its camera gain or sensitivity and its camera exposure time depending on illuminance of a subject, to thereby maintain brightness of its imaged picture at a desired level. However, there is a tradeoff between the length of the camera exposure time and the degradation of quality of the picture due to camera shake. In addition, the camera gain and the exposure time have respective upper limits. Thus, in an extremely low illuminance environment, the camera gain and the exposure time reach their respective upper limits, so that the imaged picture may become dark. An auxiliary light may be used to increase the illuminance of the subject.

Japanese Laid-open Patent Application Publication JP 2004-133006-A published on Apr. 30, 2004 describes an imaging device. The imaging device calculates an exposure error value according to an exposure level of an image signal and an exposure level obtained by photometry. The imaging device also calculates a correction amount of the exposure error value on the basis of at least one of a setting state of the imaging device, an operation state of the imaging device, and a state of object brightness in imaging. The imaging device corrects the exposure error of the shot image using the correction amount. The correction amount for correcting the exposure error of the shot image is limited so as to prevent an excessively corrected imaged result, and a correction range of the correction amount is changed in accordance with the setting state and the operation state of the imaging device and the state of the object brightness in imaging.

Japanese Laid-open Patent Application Publication JP 2004-166147-A published on Jun. 10, 2004 describes automatic adjustment of an image quality. The automatic adjustment adjusts a quality of an image using a degree of brightness of a subject obtained from image generation record information. Thus, the quality of the image can be adjusted appropriately according to the brightness of the subject.

Japanese Laid-open Patent Application Publication JP 2007-096477-A published on Apr. 12, 2007 describes a camera. The camera includes an image sensor for capturing an image of a subject, a camera shake detection unit for detecting camera shake information from the image, a camera shake information recording unit for recording a shooting condition during shooting and the detected camera shake information in association with each other, and a camera shake correction unit. The camera shake correction unit extracts the camera shake information corresponding to the shooting condition in relationship with the shooting condition by referring to the camera shake information recording unit based on the shooting condition, and corrects the camera shake based on the extracted camera shake information. Thus, a camera is provided with optimized camera shake correction according to the personality of a user and a photographing environment.

### SUMMARY

According to an aspect of the embodiment, an electronic apparatus includes an imager unit, a control unit, a brightness correction determiner unit, and a corrector unit. The imager unit images a picture. The control unit obtains, from the imager unit, data of the imaged picture and an imaging condition applied to the picture. The brightness correction determiner unit compares the obtained imaging condition with a threshold and determines whether or not to correct brightness of the data of the imaged picture. In response to the determination by the determiner unit to correct the brightness, the corrector unit corrects the data of the imaged picture so that the brightness of the imaged picture is increased in accordance with a brightness correction function.

According to another aspect of the embodiment, an electronic apparatus includes an imager unit, a brightness correction determiner unit, and a corrector unit. The imager unit images a picture. The brightness correction determiner unit obtains, from the imager unit, data of the imaged picture and an imaging condition of the imager unit applied to the picture, compares the obtained imaging condition with a threshold, and determines whether or not to correct brightness of the data of the imaged picture. In response to the determination by the determiner unit to correct the brightness, the corrector unit corrects the data of the imaged picture so that the brightness of the imaged picture is increased in accordance with a brightness correction function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of a configuration of an electronic apparatus or device including a digital camera module, in accordance with an embodiment of the present invention;

FIG. 2 illustrates an example of a configuration of a camera shake corrector unit;

FIG. 3 illustrates an example of the relationship between a desired level of the gain and exposure time in combination of the camera module and an actual level of the gain and exposure time in combination of the camera module, relative to variable subject brightness or illuminance, by a solid line;

FIG. 4 illustrates an example of the relationship between a desired level of the gain and exposure time in combination of the camera module and an actual level of the gain and exposure time in combination of the camera module, and a brightness-corrected level, relative to the variable subject brightness;

FIG. 5 illustrates an example of the relationship between a desired level of the gain and exposure time in combination of the camera module and an actual level of the gain and exposure time in combination of the camera module, and another brightness-corrected level, relative to the variable subject brightness;

FIG. 6 illustrates two examples of controlled loci of setting levels of the camera exposure time and the camera gain for increasing the brightness of an imaged picture for a dark subject of variable brightness in the camera module, as indicated by an alternate long and short dash line and a broken line, respectively;

FIG. 7 illustrates an example of a brightness correction factor function representing the relationship of the brightness correction factor for the picture imaged by the camera module to be corrected, relative to the variable brightness index of the imaged picture, in accordance with the embodiment of the invention;

FIG. 8 illustrates an example of another brightness correction factor function representing the relationship of the brightness correction factor for the picture imaged by the camera module to be corrected, relative to the variable brightness index of the imaged picture;

FIG. 9 illustrates an example of a threshold function representing a change of the threshold of the imaged picture similarity for noise cancellation in the motion detection, relative to the variable brightness correction factor provided by a brightness correction determiner unit or a correction factor determiner unit of the picture processor, in accordance with the embodiment of the invention;

FIG. 10 illustrates an example of an edge enhancement magnitude function representing a corrected change of the edge enhancement magnitude, relative to the variable brightness correction factor provided by the picture processor;

FIG. 11 illustrates an example of a flowchart for the brightness correction of the imaged picture from the camera module, which is executed by the camera management processor, the picture processor 40 and the recorder unit;

FIG. 12 illustrates an example of another flowchart for correcting the brightness of the imaged picture from the camera module, which is executed by the camera management processor, the picture processor and the recorder unit, in accordance with another embodiment of the invention;

FIG. 13 illustrates an example of another flowchart for the brightness correction and camera shake correction of the imaged picture from the camera module, which is executed by the camera management processor, the picture processor and the recorder unit, in accordance with a further embodiment of the invention;

FIG. 14 illustrates an example of a still further flowchart for the brightness correction and the camera shake correction of the imaged picture from the camera module, which is executed by the camera management processor, the picture processor and the recorder unit; and

FIGS. 15 and 16 illustrate respective examples of the brightness correction functions or the tone curves which represent the relationships between the input pixel value and the output pixel value for the correction performed by the brightness corrector unit.

### DESCRIPTION OF PREFERRED EMBODIMENTS

An electronic apparatus or device having a digital camera module such as a mobile telephone, and the digital camera module thereof have been made smaller, and hence a lens and a camera sensor thereof have been also made smaller. As a result, the upper limit of the camera gain for the brightness of the digital camera module is reduced. There is also a need for such an electronic apparatus having no auxiliary light for reducing a size of the electronic apparatus.

The inventors have recognized that even if the camera gain and the exposure time of the camera module of the electronic apparatus have the upper limits, a dark picture imaged by the camera module in an extremely low illuminance environment can be made useable by processing the dark picture so that the brightness thereof is increased to thereby improve the quality of the dark picture. The inventors have also recognized that every time the picture is imaged, brightness of the imaged picture can be adapted to be corrected, to thereby store and display the corrected picture, so that a user need not additionally or repetitively shoot the same picture uselessly and a desired amount of picture memory can be reduced.

It is an object in one aspect of the embodiment to improve a picture quality of a camera module in a low illuminance environment.

It is another object in another aspect of the embodiment to provide an electronic apparatus or device capable of improving a picture quality of a camera module in a low illuminance environment.

According to the aspects of the embodiment, an electronic apparatus or device capable of improving a picture quality of a camera module in a low illuminance environment can be provided.

Non-limiting preferred embodiments of the present invention will be described with reference to the accompanying drawings. Throughout the drawings, similar symbols and numerals indicate similar items and functions.

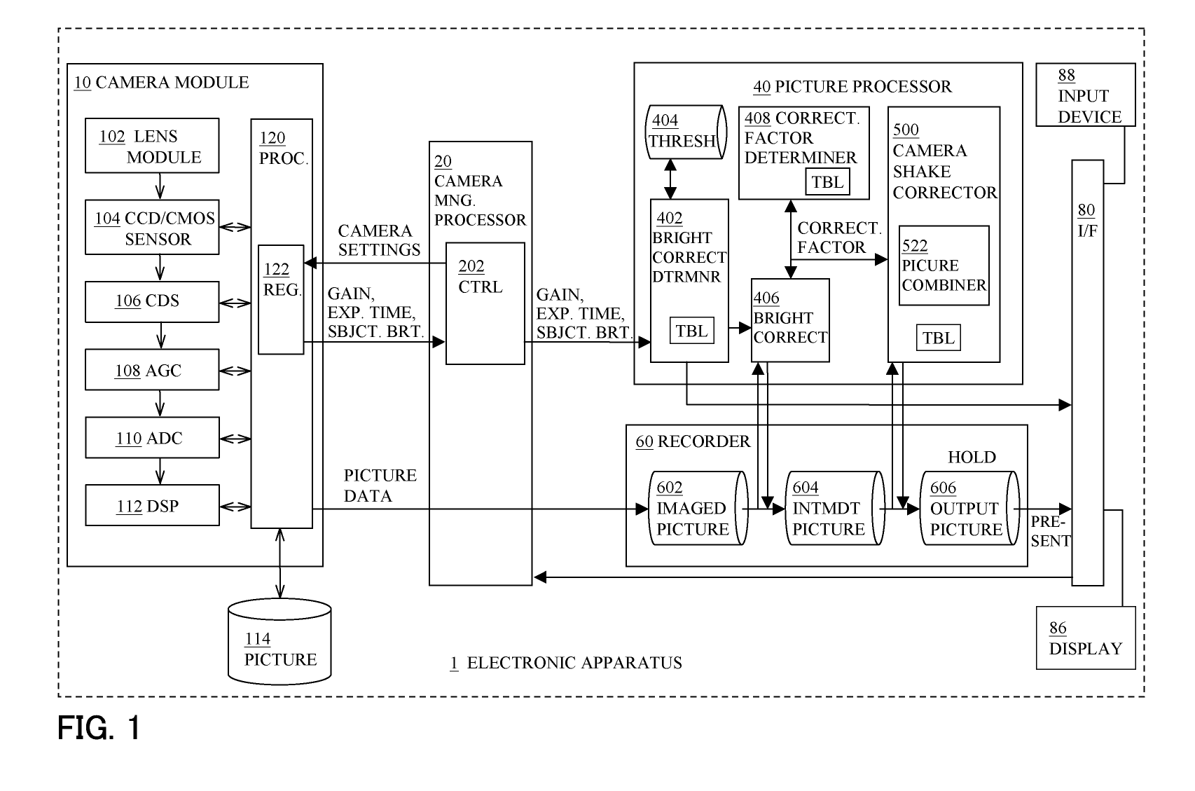

FIG. 1 illustrates an example of a configuration of an electronic apparatus or device 1 including a digital camera module 10, in accordance with an embodiment of the present invention. The electronic apparatus 1 further includes a camera management processor (CPU) 20, a picture processor (CPU) 40, a recorder unit 60, and a user interface (I/F) 80 coupled to a display 86 and an input device 88 (e.g., keys). Alternatively, the camera management processor 20 may be integrated with the picture processor 40. Alternatively, the camera management processor 20 and the picture processor 40 may be incorporated as a post-processing unit into the digital camera module 10.

The camera module 10 includes a lens module 102, an imaging CCD/CMOS sensor 104, a correlated double sampler (CDS) 106, an automatic gain controller (AGC) 108, an analog/digital converter (ADC) 110, a digital signal processor (DSP) 112, and a camera processor (CPU) 120 coupled to a picture memory area 114.

The CCD/CMOS sensor 104 images a subject through the lens module 102 according to the set exposure time, and generates an analog picture. The correlated double sampler 106, the automatic gain controller 108 and the analog/digital converter 110 generate a digital picture. The digital signal processor 112 provides output data of a digital picture in a given format. The camera management processor 20 sets the exposure time of the CCD/CMOS sensor 104 and the gain of the automatic gain controller 108, by writing the exposure time and the gain into a register (REG) 122 of the camera processor 120. The camera management processor 20 is capable of reading the currently set gain and exposure time in the camera module 10 and the viewfinder illuminance of the imaged subject which are held in the register 122. A desired gain and a desired exposure time for the camera module 10 are determined in accordance with the brightness or the illuminance of the subject.

The camera management processor 20 includes a controller 202 which controls the camera module 10. The camera management processor 20 obtains the data of the camera gain, i.e. the gain of the AGC 108, the exposure time and the subject illuminance from the camera module 10, and supplies these pieces of data to the picture processor 40. The camera management processor 20 also receives the imaged picture data from the camera module 10, and supplies it to the recorder unit 60. The camera management processor 20 may be implemented at least partly in the form of hardware such as an integrated circuit, or at least partly in the form of software as a program to run or be implemented on a processor.

Alternatively, the camera module 10 may include the lens module 102, the CCD/CMOS sensor 104, the correlated double sampler (CDS) 106, the automatic gain controller (AGC) 108 and the analog/digital converter (ADC) 110, as one module without a camera DSP, and may include the digital signal processor (DSP) 112 and the camera processor (CPU) 120 coupled to the picture memory area 114, as one separate DSP module.

The picture processor 40 includes a brightness correction determiner unit 402, a brightness corrector unit 406, a brightness correction factor determiner unit 408, and a camera shake corrector or stabilizer unit 500 including a picture combiner unit 522. The brightness correction determiner unit 402 determines whether or not the brightness of the imaged picture is to be corrected based on a threshold stored in a threshold memory area 404. The brightness corrector unit 406 corrects the brightness of the imaged picture in accordance with a correction factor. The brightness correction factor determiner unit 408 determines the brightness correction factor. The picture processor 40 processes the imaged picture data and intermediate picture data stored in the recorder unit 60 in accordance with the data of the camera gain, the exposure time and the subject illuminance from the camera management processor 20. The picture processor 40 then stores, in the recorder unit 60, the processed pictures as intermediate picture data and output picture data. The picture processor may be implemented at least partly in the form of hardware such as an integrated circuit, or at least partly in the form of software as a program to run or be implemented on a processor.

The recorder unit 60 includes an imaged picture memory area 602, an intermediate picture memory area 604 and an output picture memory area 606. The imaged picture memory area 602 stores the imaged picture data received from the camera management processor 20. The intermediate picture memory area 604 stores, as the intermediate picture data, the imaged picture data which is corrected as necessary. The output picture memory area 606 stores, as the output picture data, the intermediate picture data which is processed as necessary.

The user interface 80 is coupled to the display 86 and the input device 88 including the keys. The user interface 80 supplies a user key input to the processor 20, and presents information related to the picture brightness, correction and the like, and also the imaged picture and processed picture, on the display 86.

In FIG. 1, the camera module 10 may image a plurality of continuous pictures or continuously shoot them in response to a single depression of a shutter-release button by the user, and store the data of the imaged pictures into the imaged picture memory area 602. The brightness correction determiner unit 402 obtains, from the camera management processor 20, the camera gain and exposure time of the imaged picture, and possibly the subject illuminance and/or the desired camera gain and exposure time. The brightness correction determiner unit 402 then converts the camera gain, the exposure time and the illuminance to a brightness index. The brightness correction determiner unit 402 then compares the resultant brightness index of the imaged picture with a desired brightness index or with a corresponding threshold in the intermediate picture memory area 404, and determines whether or not to correct the brightness of the imaged picture. The brightness correction determiner unit 402 may compare only the exposure time or only the gain with the threshold, in accordance with the settings of the camera exposure time and the camera gain.

If it is determined that the brightness is to be corrected, the brightness corrector unit 406 retrieves the imaged picture data from the imaged picture memory area 602, corrects the brightness of the imaged picture in accordance with a desired brightness correction function or a desired tone curve and with the desired correction factor or the correction factor determined by the brightness correction factor determiner unit 408. The brightness corrector unit 406 then stores the corrected picture data into the intermediate picture memory area 604. The camera shake corrector unit 500 retrieves the data of a plurality of brightness-corrected or uncorrected intermediate pictures from the intermediate picture memory area 604, and then derives an output camera-shake-corrected picture from the intermediate pictures.

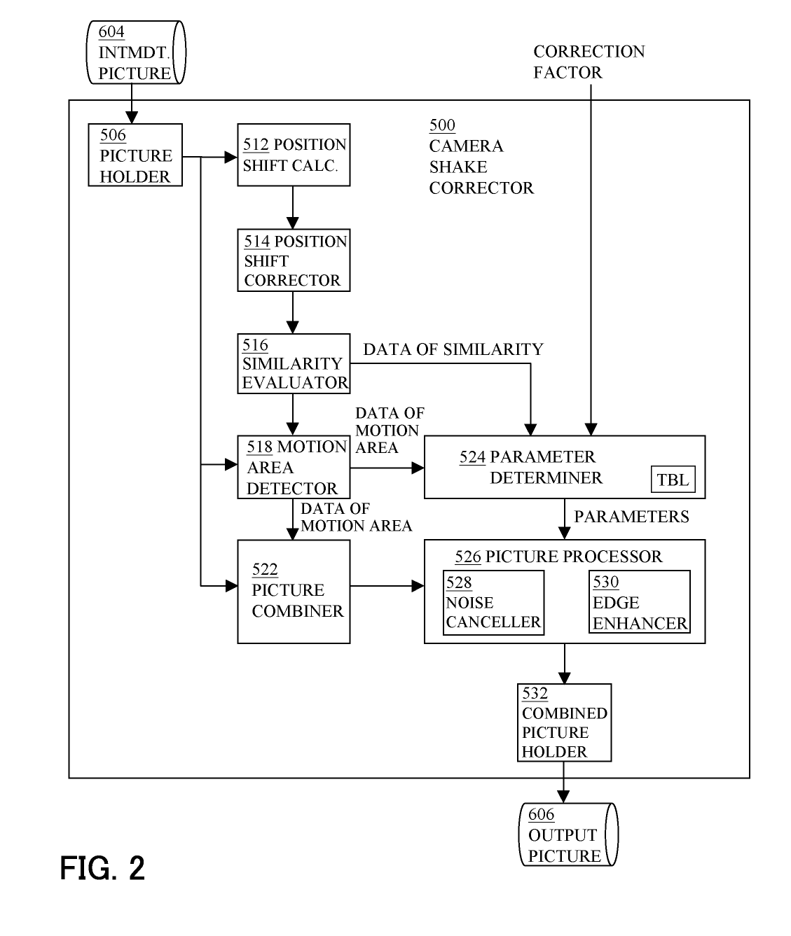

FIG. 2 illustrates an example of a configuration of the camera shake corrector unit 500. The camera shake corrector unit 500 includes a picture holder 506 coupled to the intermediate picture memory area 604, a position shift calculator unit 512 coupled to the picture holder unit 506, a position shift corrector unit 514 coupled to the calculator unit 512, a similarity evaluator unit 516 coupled to the position shift corrector unit 514, a motion area detector unit 518 coupled to the picture holder unit 506, the picture combiner unit 522, a parameter determiner unit 524, a picture processor unit 526, and a combined picture holder unit 532 coupled to the output picture memory area 606. The picture holder 506 holds the intermediate images. The parameter determiner unit 524 determines or selects picture processing parameters. The picture processor unit 526 includes a noise canceller or remover unit 528 and an edge enhancer unit 530. FIG. 2 can also be viewed as a flow diagram for camera shake correction including steps of the elements 506 to 532.

The position shift calculator unit 512 of the camera shake corrector unit 500 calculates the general position shifts between the entire intermediate pictures stored in the intermediate picture memory area 604. In accordance with the calculated position shifts, the position shift corrector unit 514 generates other intermediate pictures where the general position shifts have been corrected. The similarity evaluator unit 516 calculates the similarity between corresponding areas of the respective intermediate pictures, and evaluates the calculated similarity.

The motion area detector unit 518 detects a motion area in accordance with data of the evaluated similarity between the corresponding areas of the respective intermediate pictures. The picture combiner unit 522 processes the intermediate pictures in accordance with data related to the motion areas to generate a combined picture. The picture combiner unit 522 may determine a combined area of pixel values, for example, by averaging between corresponding areas of pixel values in the respective position-shift-corrected intermediate pictures and by selecting one area of corresponding motion areas of pixel values in the respective intermediate pictures.

The motion area detector unit 518 may include, for example, a threshold setter unit, a motion determiner unit, an isolated point noise determiner unit and a determination buffer memory (not illustrated). The threshold determiner unit calculates to determine first and second thresholds, and outputs them to the motion determiner unit and the isolated point noise determiner unit, respectively. The first and second thresholds are determined in accordance with the exposure time and/or the gain value.

The motion determiner unit determines whether or not the corresponding areas between the pictures represent a motion in accordance with the amount of shift Δ. If it is determined that the difference Δ is larger than the first threshold, the motion determiner unit determines that they represent a motion, and outputs the motion determination to the determination buffer memory. The determination buffer memory may record, for example, the motion determination in the bitmap format. If it is determined that there is a motion between corresponding areas of pixels (x, y) in the respective pictures in comparison with each other, the determiner unit sets 1's (ones) to corresponding pixel positions M(x, y) in the bitmap. If it is determined that there is no motion between corresponding areas of pixels in the respective pictures, the determiner unit sets “0's” (zeros) to corresponding pixel positions M(x, y) in the bitmap.

The isolated point noise determiner unit determines whether or not the position M(x, y) of the pixel determined as representing a motion is an isolated point noise. If it is determined that it is an isolated point noise, the isolated point noise determiner unit determines the position M(x, y) as representing no motion (“0”). For example, taking account of the resultant determinations of surrounding eight pixel positions adjacent to the position M(x, y) of the current pixel, the number of pixels determined as representing a motion is counted. If the count of the number of pixels is smaller than the second threshold, the position M(x, y) of the current pixel is determined as an isolated point noise, and is set as representing no motion (“0”).

The parameter determiner unit 524 determines the parameters to be used for the picture processing by the picture processor 526 in accordance with the brightness correction factor from the brightness corrector unit 406 or the correction factor determiner unit 408, the similarity data from the similarity evaluator unit 516 and the motion area data from the motion area detector unit 518. The picture processor 526 post-processes the combined picture from the picture combiner unit 522 in accordance with the determined parameters, and stores the processed picture into the combined picture holder unit 532.

The parameter determiner unit 524 determines whether or not noise cancellation is necessary in accordance with the similarity data between corresponding areas of the respective pictures. The parameter determiner unit 524 determines to perform the noise cancellation on ones of the corresponding areas that have similarity determined as not more than the threshold. The parameter determiner unit 524 determines the number of pictures to be combined in accordance with the motion area data. In accordance with the number of pictures to be combined, the picture similarity threshold and a normal edge enhancement magnitude or factor, the parameter determiner unit 524 then determines a corrected magnitude of the edge enhancement as a parameter. The parameter determiner unit 524 may further determine other desired parameters in accordance with the similarity data and the motion area data.

The parameter determiner unit 524 may set parameters, for example, the number of pictures to be combined and the size (as a noise cancellation parameter) of a weighted average filter, a median filter or a blurring, low-pass filter for the noise cancellation. For example, the parameter determiner unit 524 may determine or set, as the filter size, “5×5” for areas where the number of pictures to be combined is one, “3×3” for areas where the number of pictures to be combined is two, and “1×1” for areas where the number of pictures to be combined is three, and stores the filter size into a memory area.

The parameter determiner unit 524 determines particular values of the parameters to be used by the picture processor 526, such as the threshold of the picture similarity for the noise cancellation or filtering to be used by the picture processor 526 (e.g., 1 to 2, or 100 to 200%) and the magnitude of two-dimensional edge enhancement or edge compensation or filtering (e.g., 0.5 to 1, or 50 to 100%).

The picture processor 526 cancels the image noise of each area and performs edge enhancement in accordance with the parameters determined by the parameter determiner unit 524, for example, the picture similarity threshold and the magnitude of the edge enhancement, and outputs the resultant picture data as the combined picture (532). The noise canceller unit 528 performs noise cancellation on each area of the pictures to be combined in accordance with the corresponding noise cancellation parameters, for example, the filter size.

After the number of pictures or corresponding areas to be combined for the corresponding areas is determined, for example, the edge enhancement or noise cancellation may be performed in accordance with the determined number of the pictures or corresponding areas to be combined for the corresponding areas of the pictures to be combined. If the number of pictures to be combined is not larger than a threshold number (e.g., 1), then the noise cancellation may be performed. On the other hand, if the number of pictures to be combined is smaller than the threshold number, then the edge enhancement may be performed.

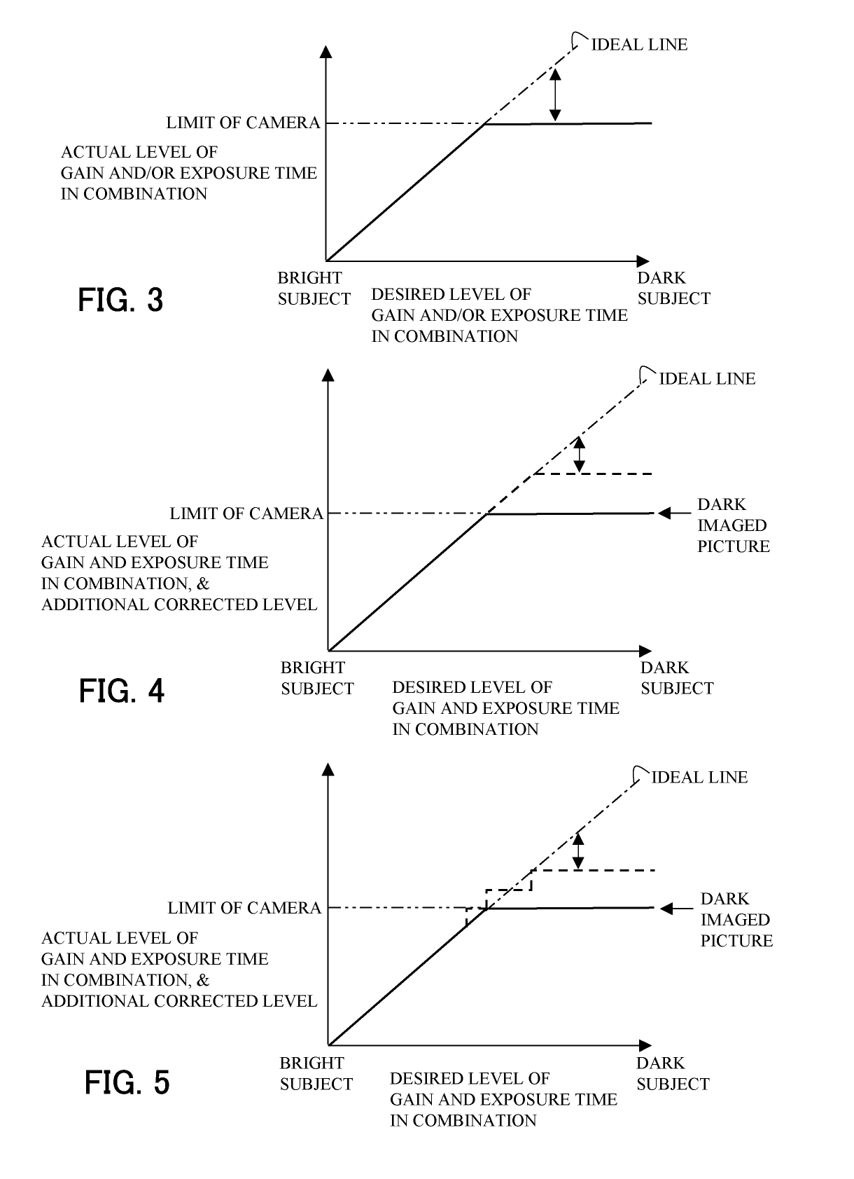

FIG. 3 illustrates an example of the relationship between a desired level of the gain and exposure time in combination of the camera module and an actual level of the gain and exposure time in combination of the camera module 10, relative to variable subject brightness or illuminance, by a solid line. In FIG. 3, each of the vertical and horizontal axes represent a total of the gain value and the exposure time in combination that is converted to a gain, or an index (e.g., between 0 and 150%) representative of the total. It is assumed and ideal or desirable that the actual level of the gain and exposure time in combination of the camera module 10 is linearly proportional to the desired level of the gain and the exposure time in combination, as indicated by the sloping linear alternate long and short dash line. However, as indicated by the solid line, for size reduction of the apparatus, the actual maximum level (along the vertical axis) of the gain and exposure time of the camera module 10 has an upper limit that is lower than the desired level. Thus, in the camera module 10, there is a limit to increasing the luminance or the lightness of a dark picture imaged at low illuminance with respect to the gain and the exposure time. Thus, an imaged picture of a dark subject where the desired level of the gain and the exposure time in combination is higher than the maximum limit in the camera module 10 cannot be made brighter, and hence may not be used by the user.

FIG. 4 illustrates an example of the relationship between a desired level of the gain and exposure time in combination of the camera module and an actual level of the gain and exposure time in combination of the camera module 10, and a brightness-corrected level, relative to the variable subject brightness. In this case, even an imaged picture of a dark subject where the desired level of its gain and exposure time in combination is higher than the maximum limit in the camera module 10 can be corrected to increase the gain of the brightness or the luminance of the imaged picture, as indicated by the broken line, to get close to the ideal line by post-processing the data of the imaged picture. Thus, the brightness of a picture of a subject which is somewhat darker than the limit to increasing the luminance of the camera module 10 can be increased to a level at which the user can use the picture.

FIG. 5 illustrates an example of the relationship between a desired level of the gain and exposure time in combination of the camera module and an actual level of the gain and exposure time in combination of the camera module 10, and another brightness-corrected level, relative to the variable subject brightness. In this case, even an imaged picture of a dark subject where the desired level of its gain and exposure time in combination is higher than the maximum limit in the camera module 10 can be corrected to increase the gain in a stepwise or discrete manner, as indicated by the broken line, to get close to the ideal line by post-processing the data of the imaged picture. Thus, the brightness of a picture of a subject which is somewhat darker than the limit to increasing the luminance of the camera module 10 can be increased to a level at which the user can use the picture.

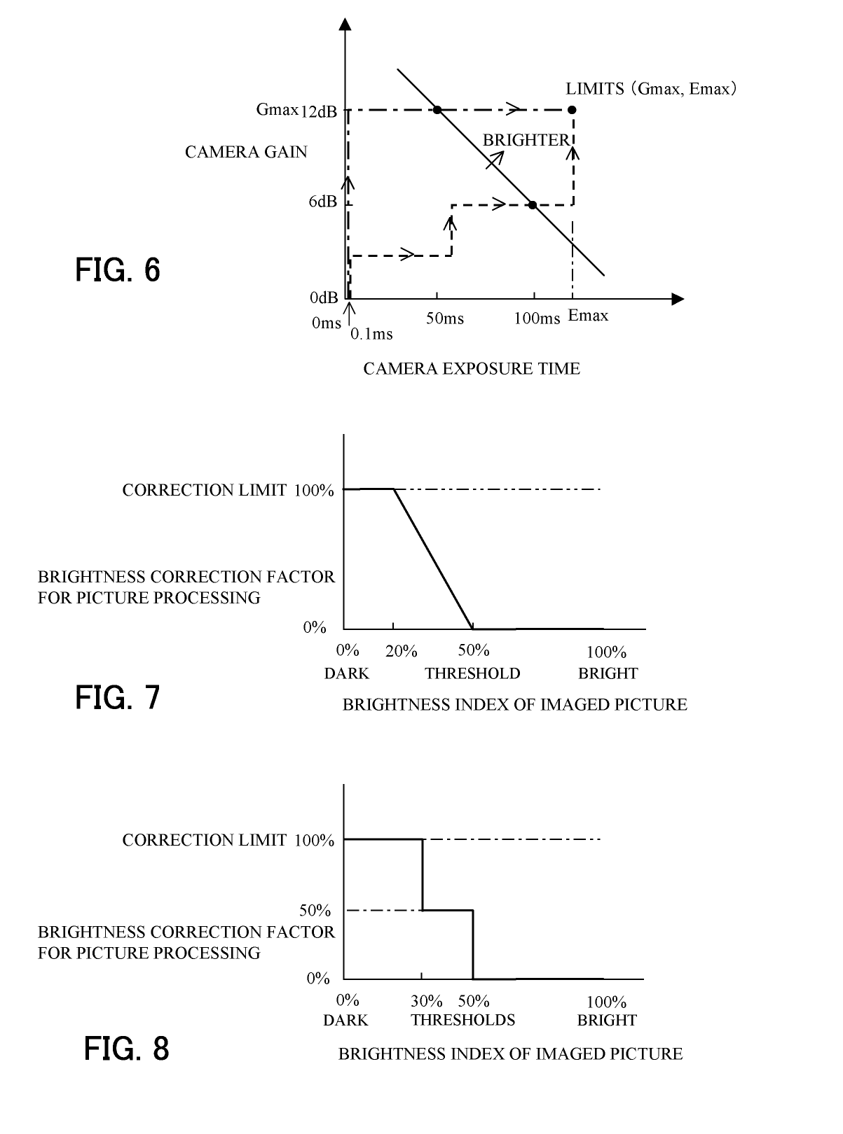

FIG. 6 illustrates two examples of controlled loci of setting levels of the camera exposure time and the camera gain for increasing the brightness of an imaged picture for a dark subject of variable brightness in the camera module 10, as indicated by an alternate long and short dash line and a broken line, respectively. The values of the camera exposure time and the camera gain are determined depending on their respective loci and the viewfinder illuminance.

In the one example, to increase the brightness of the imaged picture, first, the gain of the AGC 108 is gradually increased from 0 dB to 12 dB. If this gain increase does not provide sufficient brightness of the imaged picture, then the exposure time of the CCD/CMOS sensor 104 is gradually increased from 0.1 ms to 125 ms. In this case, it is assumed that the upper limit of the camera exposure time is 125 ms, and the upper limit of the camera gain is 12 dB.

In the other example, to increase the brightness of the imaged picture, first, the gain of the AGC 108 of the camera is gradually increased from 0 dB to 3 dB. If this gain increase does not provide sufficient brightness of the imaged picture, then the exposure time of the CCD/CMOS sensor 104 is gradually increased from 0.1 ms to 60 ms. If this exposure time increase does not yet provide sufficient brightness of the imaged picture, then the gain is further gradually increased from 3 dB to 6 dB. If this gain increase does not yet provide sufficient brightness of the imaged picture, then the exposure time of the CCD/CMOS sensor 104 is further gradually increased from 60 ms to 125 ms. If this exposure time increase does not yet provide sufficient brightness of the imaged picture, then the gain is further gradually increased from 6 dB to 12 dB. In this case, it is assumed that the maximum limit level of the gain of the AGC 108 is 12 dB, and the maximum limit level of the exposure time of the CCD/CMOS sensor 104 is 125 ms.

The combination of the increased gain and the increased exposure time contributes to the brightness or the luminance of the imaged picture. In this case, the 6-dB increase in the gain generally corresponds to doubling (100 ms/50 ms) the exposure time.

Until or unless the increased gain and the increased exposure time both reach the respective maximum limits, the detected brightness Bn of the CCD/CMOS sensor 104 can be expressed by the following formula, for the gain Gn and the exposure time En at a current point of time, and a constant α.

Bn=Gn/6+log₂(En)+α

This formula may be also used for the brightness correction determination or as the picture brightness index.

For the determination whether or not to correct the brightness, a brightness Bth not more than a maximum value Bmax (Bth≦Bmax) may be used as the threshold. Alternatively, in the simple locus (transition) where the exposure time is increased after the gain is increased up to 12 dB in the exposure time and camera gain settings of the first example of FIG. 6, an exposure time Eth not more than a maximum value Emax (Eth≦Emax) may be used as the threshold.

FIG. 7 illustrates an example of a brightness correction factor function representing the relationship of the brightness correction factor for the picture imaged by the camera module 10 to be corrected, relative to the variable brightness index of the imaged picture, in accordance with the embodiment of the invention. This brightness correction factor function representing the relationship of the correction factor relative to the brightness index of the imaged picture may be used by the correction factor determiner unit 408.

When the brightness index of the imaged picture is not higher than the threshold 50% and higher than 20% on the brightness scale of the picture processor 40 (the elements 402 to 408), the brightness correction factor may be determined and set so as to gradually increase within a range of 0% to 100% as the imaged picture becomes darker, depending on the brightness. When the brightness index is not higher than 20%, the brightness correction factor may be determined and set to be the maximum limit 100%. When the brightness index of the imaged picture is higher than 50% and is not higher than 100%, the correction factor may be determined to be zero (0). In FIG. 7, the percentage 100% of the brightness index represents a possible maximum value. Thus, the brightness correction factor substantially monotonously increases, as the brightness index of the imaged picture becomes lower than the threshold.

FIG. 8 illustrates an example of another brightness correction factor function representing the relationship of the brightness correction factor for the picture imaged by the camera module 10 to be corrected, relative to the variable brightness index of the imaged picture.

When the brightness index of the imaged picture is not higher than 50% and higher than 30% on the brightness scale of the picture processor 40 (the elements 402 to 408), the brightness correction factor is determined and set to be as high as 50%. When the brightness level is not higher than 30%, the brightness correction factor is determined and set to be the maximum limit 100%. When the brightness index of the imaged picture is higher than the threshold 50% and is not higher than 100%, the correction factor may be determined to be zero (0). Thus, the brightness correction factor substantially monotonously increases as the brightness index of the imaged picture becomes lower than the threshold.

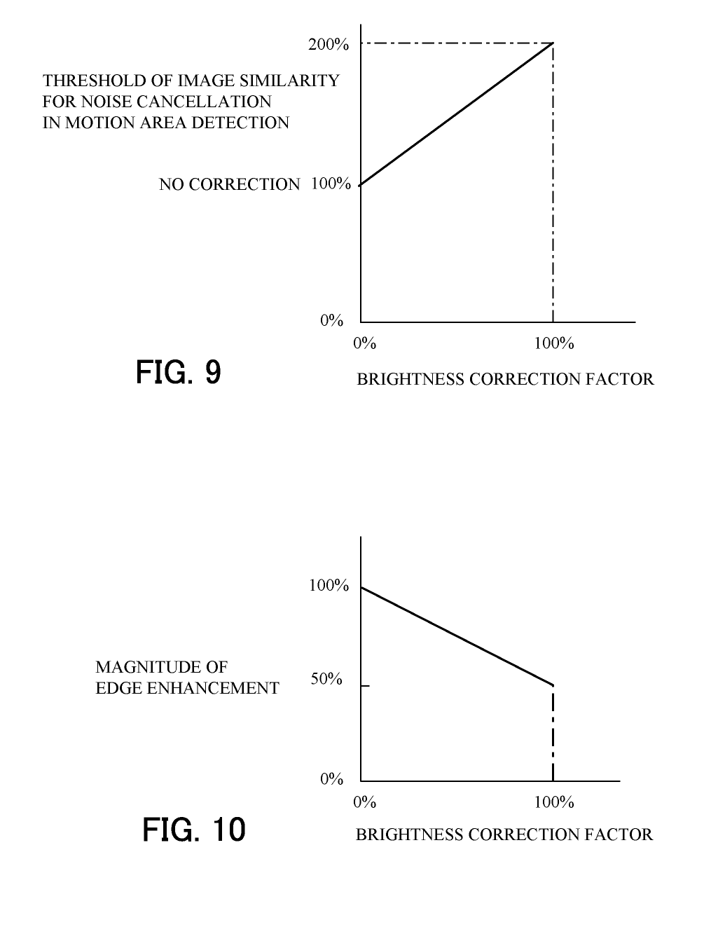

FIG. 9 illustrates an example of a threshold function representing a change of the threshold of the imaged picture similarity for noise cancellation in the motion detection, relative to the variable brightness correction factors from 0% to 100% provided by the variable brightness correction determiner unit 402 or the correction factor determiner unit 408 of the picture processor 40, in accordance with the embodiment of the invention.

When the similarity between corresponding areas of the plurality of respective pictures is lower than the threshold according to the evaluation of the similarity, it may be determined that the area with the lower similarity includes a non-negligible or significant noise, and the area with the lower similarity may not be used for generating a combined picture, and/or the noise cancellation may be performed on the area with the lower similarity in the combined picture. When the brightness correction factor is 0%, a normal threshold of the picture similarity for noise cancellation in the motion detection may be used. On the other hand, the threshold function is such that the picture similarity for the noise cancellation substantially monotonously increases as the brightness correction factor increases. When the brightness correction factor is 100%, a threshold 200% which is twice the normal threshold (100%) of the picture similarity for the noise cancellation may be used. This prevents failure of cancelling noise in the corrected picture having the increased difference or contrast of the pixel brightness and luminosity or luminance that is increased by the brightness correction.

FIG. 10 illustrates an example of an edge enhancement magnitude function representing a corrected change of the edge enhancement magnitude, relative to the variable brightness correction factors 0% to 100% provided by the picture processor 40.

For the edge enhancement, the edge-enhancement filtering may be performed on the pixels of a particular area representing an edge so that the brightness levels of the pixels are corrected to enhance the edge. For the brightness correction factor of 0%, the edge enhancement is performed with uncorrected 100% of the normal enhancement factor as the magnitude of edge enhancement. For the brightness correction factor of 100%, the performed edge enhancement is reduced to 50% of the normal enhancement factor as the magnitude of the edge enhancement. Coefficients of the edge enhancement filter for generating an edge enhancement signal to be added to the picture signal may be multiplied by the magnitude of edge enhancement, or the generated edge enhancement signal to be added to the picture signal may be multiplied by the magnitude of edge enhancement. Thus, the magnitude of edge enhancement substantially monotonously decreases, as the brightness correction factor increases. This prevents a noise in the corrected picture having the difference (or contrast) of the pixel brightness and the luminosity or luminance, which difference is increased by the brightness correction, from being erroneously evaluated as an edge, and also prevents the edge from being excessively enhanced, in the edge enhancement filtering of the corrected picture having the brightness increased by the brightness correction.

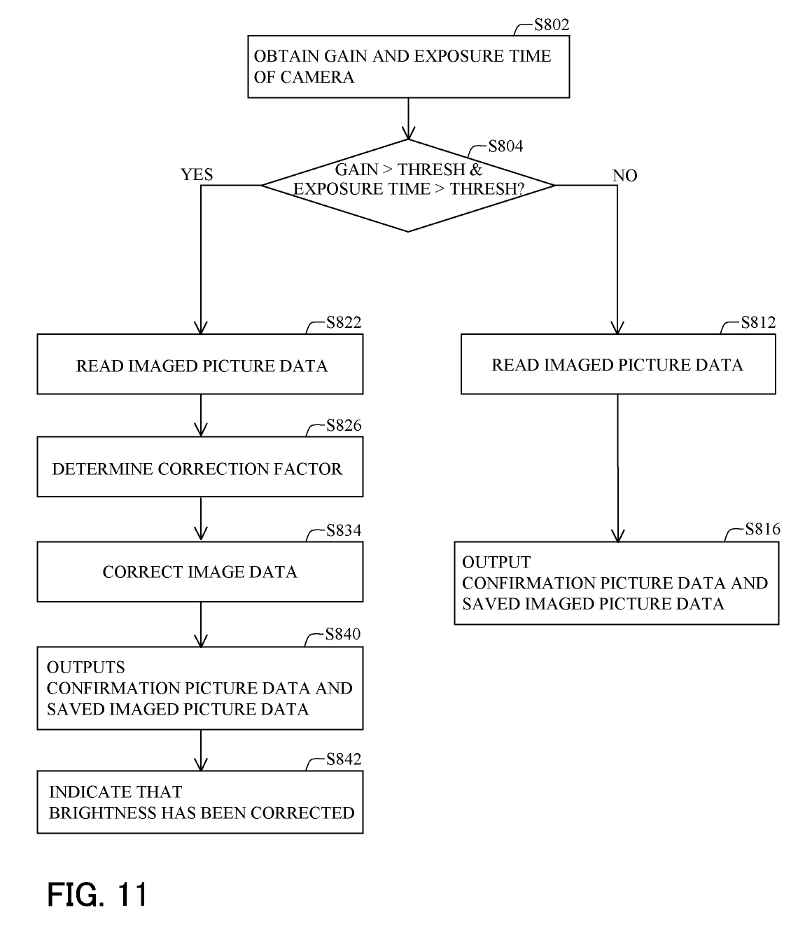

FIG. 11 illustrates an example of a flowchart for the brightness correction of the imaged picture from the camera module 10, which is executed by the camera management processor 20, the picture processor 40 and the recorder unit 60.

At Step 802, the controller 202 of the camera management processor 20 reads, from the camera module 10, the data of the actual gain and exposure time applied to the imaged picture held in the register 122, and possibly the subject illuminance and/or the desired camera gain and exposure time, and the picture processor 40 obtains the data. At Step 804, the brightness correction determiner unit 402 of the picture processor 40 determines whether the actual gain and the exposure time reach or exceed their respective given thresholds Bth. This determination may be performed by comparing only the exposure time with the threshold thereof or comparing only the gain with the threshold thereof, according to the settings of the camera exposure time and the camera gain.

If it is determined that either of them does not reach its threshold Bth, the camera management processor 20 at Step S812 retrieves the imaged picture data from the camera module 10 (the picture memory area 114), and stores it into the imaged picture memory area 602 of the recorder unit 60. At Step 816, the recorder unit 60 stores the imaged picture data into the intermediate picture memory area 604, and further, stores it into the output picture memory area 606 as confirmation picture data and saved picture data. Steps 812 to 816 are normal processing.

If it is determined at Step 804 that they both reach their thresholds Bth, the camera management processor at Step 822 retrieves the data of the related imaged pictures from the camera module 10 (the picture memory area 114), and stores it into the imaged picture memory area 602 of the recorder unit 60.

At Step 826, the brightness correction factor determiner unit 408 determines one desired correction factor (e.g., 100%).

At Step 834, based on the correction factor determined by the brightness correction determiner unit 402, the brightness corrector unit 406 processes the imaged picture data in accordance with the desired brightness correction function or the desired tone curve so as to increase their brightness.

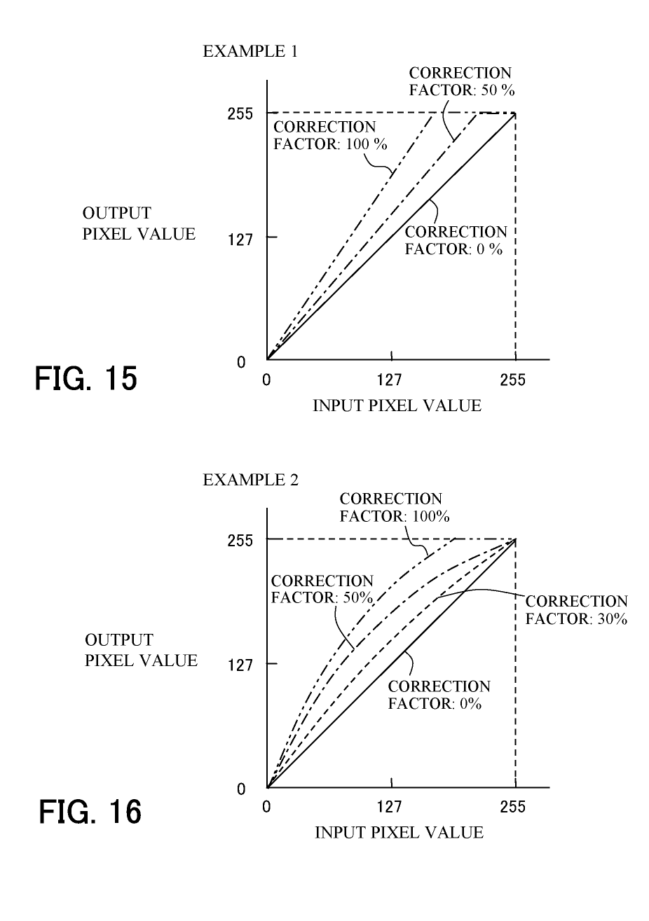

FIGS. 15 and 16 illustrate respective examples of the brightness correction functions or the tone curves which represent the relationships between the input pixel value and the output pixel value for the correction performed by the brightness corrector unit 406. The brightness corrector unit 406 may output, as intermediate picture data, the output pixel values which are corrected in brightness in accordance with the correction function straight or curved line of FIG. 15 or 16, in response to the values of the pixels of the imaged picture as the input pixel values, which straight or curved line depends on the correction factor determined in the desired range of percentages 30% to 100% for example.

At Step 840, the brightness corrector unit 406 stores the corrected imaged picture as the intermediate picture into the intermediate picture memory area 604. The recorder unit 60 stores the corrected intermediate picture in the intermediate picture memory area 604 into the output picture memory area 606 as confirmation picture data for display and saved image data in a desired format (e.g., JPEG).

At Step 842, the brightness correction determiner unit 402 may indicate that the brightness of the imaged picture has been corrected on the display 86 through the user interface 80. The user may operate the input device 88 to switch between the uncorrected imaged picture stored in the imaged picture memory area 602 for displaying and the corrected picture stored in the output picture memory area 606 for displaying. The user can delete or discard the output picture in the output picture memory area 606, when he or she determines that the corrected image cannot be used or the imaging or shooting has been a failure. However, in accordance with the embodiment, the picture corrected in brightness can be presented as the output image even if the imaged picture is somewhat dark, and hence it is more expected that the corrected picture can have desired brightness, so that the user may have fewer occasions to determine that the shooting has been a failure and discard the picture and may have fewer occasions to shoot an additional picture.

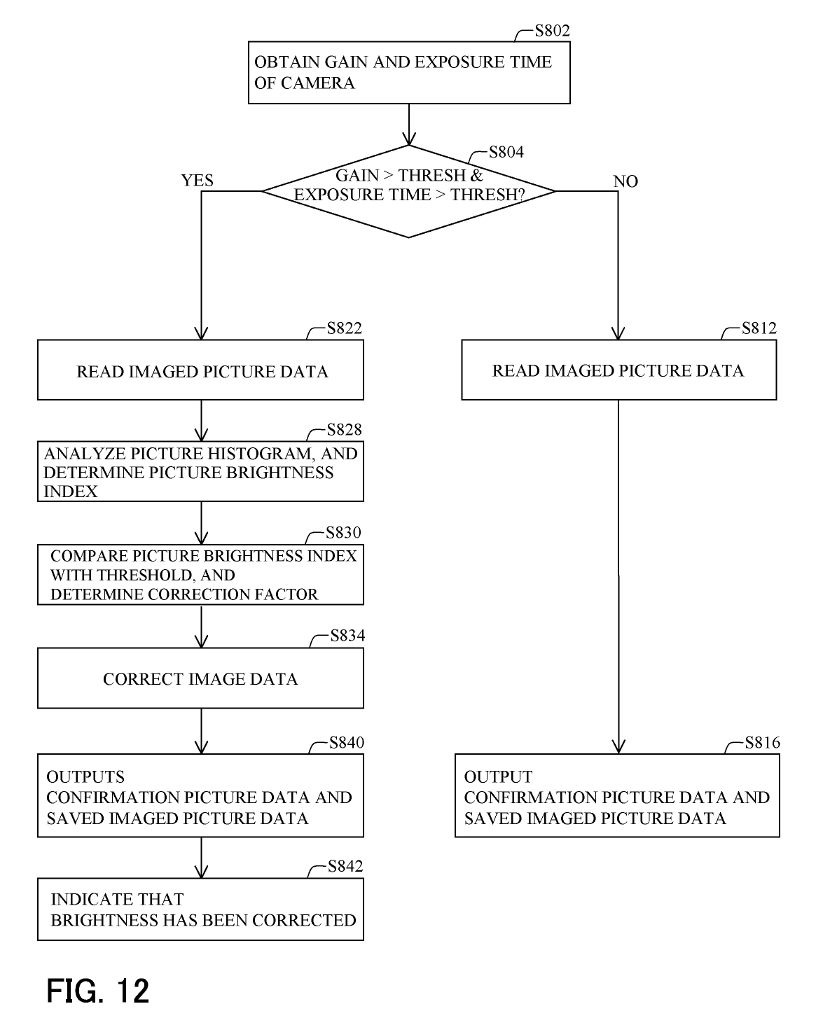

FIG. 12 illustrates an example of another flowchart for correcting the brightness of the imaged picture from the camera module 10, which is executed by the camera management processor 20, the picture processor 40 and the recorder unit 60, in accordance with another embodiment of the invention.

Steps 802 to 822 are similar to those of FIG. 11.

At Step 828, the correction factor determiner unit 408 generates and analyzes a histogram of the frequency or the number of occurrences of the pixels relative to the brightness levels of the pixels of the imaged picture, and determines the brightness index INDEX of the imaged picture. The brightness index INDEX may be, for example, a value expressed as the percentage (%) of the following relative to the maximum brightness value: (a) the average brightness in the histogram; (b) the median of the histogram; (c) the value of the pixel with the highest frequency in the histogram; (d) the average brightness in the histogram of the pixels within a range between two, lower and higher thresholds, excluding the darkest range of pixels (at brightness levels 0 to n) with lower frequencies and lower than the lower threshold and excluding the brightest range of pixels (at brightness levels m to 255) with higher frequencies and not lower than the higher threshold; and (e) the average of the brightness indices in the histograms of a plurality of divided areas of the imaged picture (e.g., the indices (a) to (d) described above which are applied to the areas).

As an alternative form, when a value representative of or corresponding to the subject brightness can be read from the CCD/CMOS sensor 104, the correction factor determiner unit 408 may normalize the subject brightness representative value read from the CCD/CMOS sensor 104 to the percentage of 0 to 100% and determines it as the brightness index. As another alternative form, until or unless the gain and the exposure time both reach the maximum limits, the correction factor determiner unit 408 may use the actual gain Gn and the actual exposure time En or the actual brightness Bn, then normalize the brightness Bn or the like to the percentage of 0 to 100%, and then determine it as the brightness index.

At Step 830, the brightness correction factor determiner unit 408 compares the brightness index (0 to 100%) of the picture with the given threshold (e.g., 50%), and further determines the brightness correction factor in accordance with the correction factor function. The brightness correction factor may be determined in accordance with the correction factor function of FIG. 7 or representing the relationship of the correction factor relative to the brightness index of the picture. This correction factor function may be stored in the form of the table TBL in the brightness correction factor determiner unit 408.

Steps 834 to 842 are similar to those of FIG. 11.

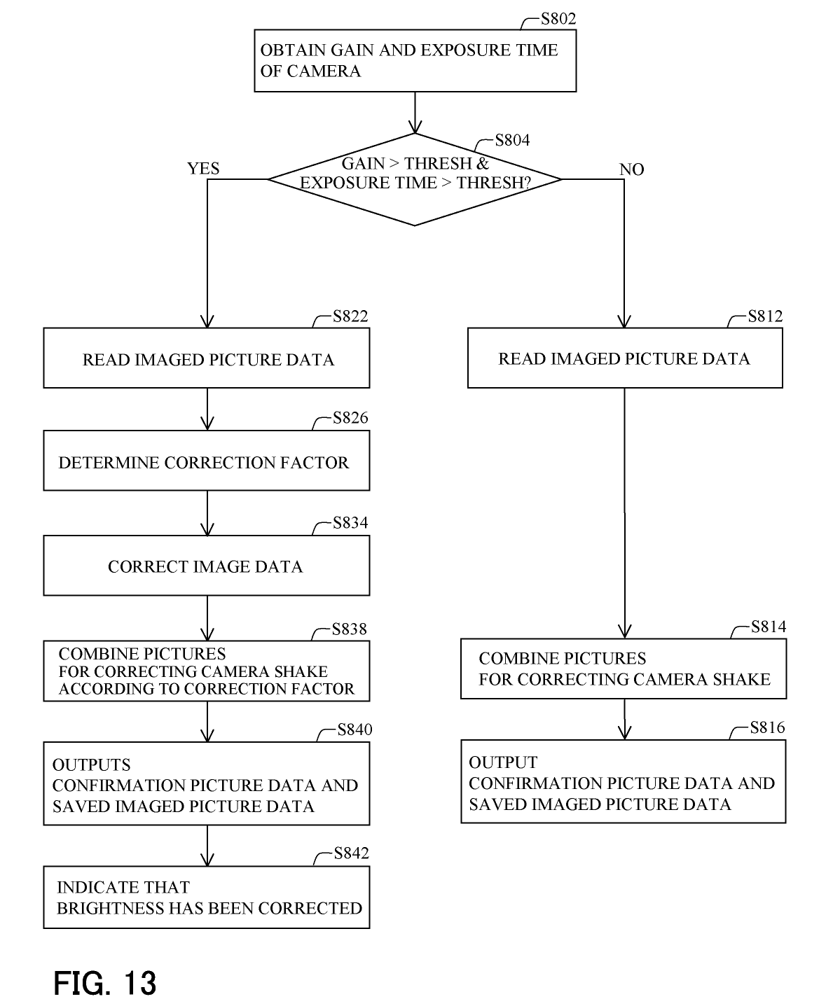

FIG. 13 illustrates an example of another flowchart for the brightness correction and the camera shake correction of the imaged picture from the camera module 10, which is executed by the camera management processor 20, the picture processor 40 and the recorder unit 60, in accordance with a further embodiment of the invention.

Steps 802 to 812 are similar to those of FIG. 11.

At Step 814, the camera shake corrector unit 500 processes the brightness-uncorrected intermediate pictures stored in the intermediate picture memory area 604 for the camera shake correction in a normal manner, and stores the resultant pictures into the combined picture holding area 532. At Step 816, the recorder unit 60 stores the combined picture data into the output picture memory area 606 as the confirmation picture data and the saved picture data.

Steps 822 to 834 are similar to those of FIG. 11.

At Step 838, the parameter determiner unit 524 of the camera shake corrector unit 500 determines a corrected threshold of the picture similarity in accordance with a desired threshold correction function and based on the brightness correction factor, and then determines whether or not to perform the noise cancellation in accordance with data of the similarity between the corresponding areas of the imaged pictures and with the corrected threshold. The corrected threshold of the picture similarity may be determined in accordance with the threshold correction function representing the relationship of the threshold relative to the brightness correction factor of FIG. 9. This correction factor may be stored in the form of the table TBL in the parameter determiner unit 524. The parameter determiner unit 524 also determines the magnitude of edge enhancement in accordance with the edge enhancement magnitude correction function and based on the brightness correction factor. The magnitude of edge enhancement may be determined in accordance with the edge enhancement magnitude function representing the relationship of the magnitude of edge enhancement relative to the brightness correction factor of FIG. 10. This edge enhancement magnitude function may be stored in the form of the table TBL in the parameter determiner unit 524.

The noise canceller unit 528 of the camera shake corrector unit 500 performs the camera shake correction in accordance with the corrected picture similarity threshold and the corrected edge enhancement magnitude, depending on the brightness correction factor (0 to 100%). This prevents failure of canceling a noise in an area of the imaged picture to be cancelled, which failure may occur as a result of increasing the difference or contrast in the pixel brightness or luminance. This further prevents a noise of the corrected picture from being erroneously evaluated as an edge, or prevents the edge from being excessively enhanced as a result of increasing the difference in brightness or luminosity.

Steps 840 to 842 are similar to those of FIG. 11.

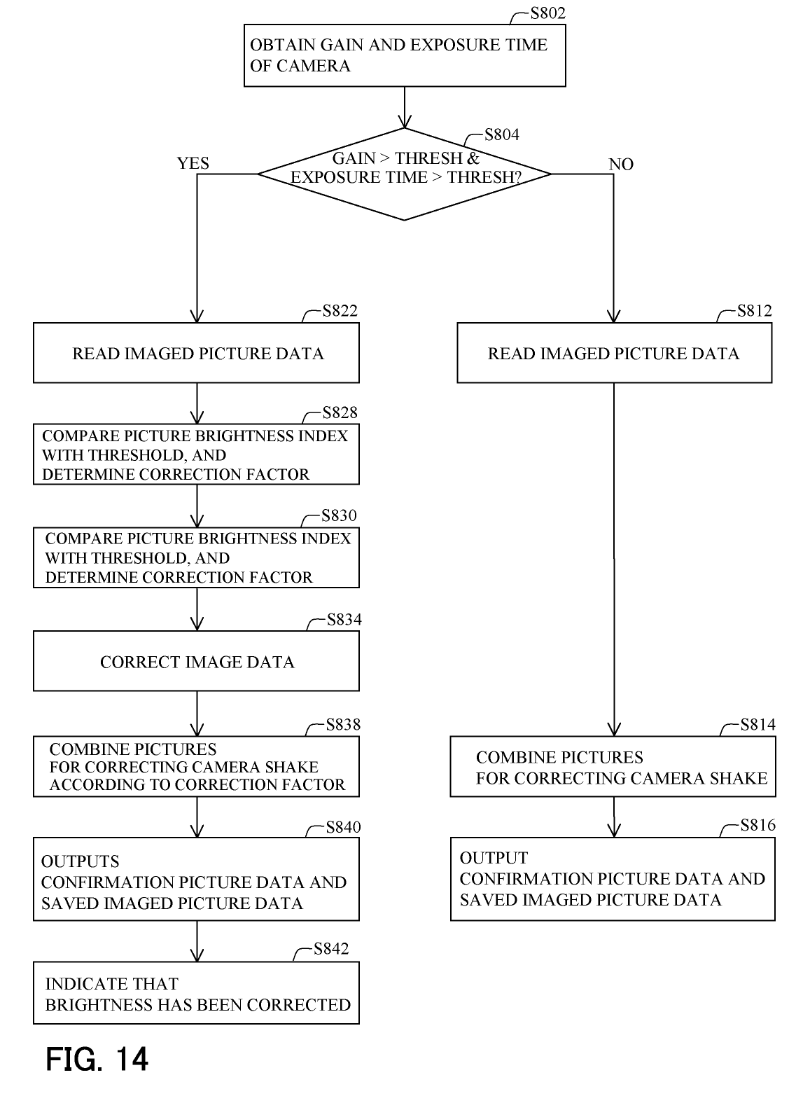

FIG. 14 illustrates an example of a still further flowchart for the brightness correction and the camera shake correction of the imaged picture from the camera module 10, which is executed by the camera management processor 20, the picture processor 40 and the recorder unit 60.

Steps 802 to 812, 816 to 834, and 840 to 842 are similar to those of FIG. 12. Steps 814 and 838 are similar to those of FIG. 13.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic apparatus comprising:
an imager unit which images a picture;
a control unit which obtains, from the imager unit, data of the imaged picture and an imaging condition applied to the picture;
a brightness correction determiner unit which compares the obtained imaging condition with a threshold and determines whether or not to correct brightness of the data of the imaged picture; and
a corrector unit which corrects, in response to the determination by the determiner unit to correct the brightness, the data of the imaged picture so that the brightness of the imaged picture is increased in accordance with a brightness correction function.

2. The electronic apparatus according to claim 1, further comprising a correction factor determiner unit which determines a correction factor in accordance with the brightness of the imaged picture and with a correction factor function, wherein
the correction factor determiner unit determines one of a plurality of candidate correction factors in accordance with a discrete or continuous correction factor function, and
the corrector unit determines the brightness correction function in accordance with the determined correction factor, so that the brightness of the picture imaged in a low illuminance environment is enhanced.

3. The electronic apparatus according to claim 1, further comprising a correction factor determiner unit which determines a correction factor in accordance with the brightness of the imaged picture and with a correction factor function, wherein
the correction factor function is such that the correction factor substantially monotonously increases as the brightness becomes lower than a threshold, and
the corrector unit determines the brightness correction function in accordance with the correction factor, so that the brightness of the picture imaged in a low illuminance environment is enhanced.

4. The electronic apparatus according to claim 1, further comprising a correction factor determiner unit which determines a brightness index of the imaged picture in accordance with a histogram of pixel data of the imaged picture, and determines a correction factor in accordance with the determined brightness index and with a correction factor function, wherein
the corrector unit determines the brightness correction function in accordance with the correction factor, so that the brightness of the picture imaged in a low illuminance environment is enhanced.

5. The electronic apparatus according to claim 1, wherein the imager unit continuously images a plurality of pictures, and
the electronic apparatus further comprises a camera shake corrector unit which combines a plurality of pictures in accordance with a detected motion between the plurality of pictures and generates one camera-shake-corrected picture.

6. The electronic apparatus according to claim 5, wherein the camera shake corrector unit determines an edge enhancement magnitude in accordance with the brightness correction factor and with an edge enhancement magnitude correction function, and enhances an edge of the combined picture in accordance with the determined edge enhancement magnitude.

7. The electronic apparatus according to claim 6, wherein the edge enhancement magnitude correction function is such that the edge enhancement magnitude substantially monotonously decreases as the brightness correction factor increases.

8. The electronic apparatus according to claim 5, wherein the camera shake corrector unit determines a picture similarity threshold for cancelling noise in accordance with the brightness correction factor and with a threshold correction function, and cancels noise of the combined picture in accordance with the determined picture similarity threshold.

9. The electronic apparatus according to claim 6, wherein the threshold correction function is such that the picture similarity threshold substantially monotonously increases as the brightness correction factor increases.

10. The electronic apparatus according to claim 2, wherein the imager unit continuously images a plurality of pictures, and
the electronic apparatus further comprises a camera shake corrector unit which combines a plurality of pictures in accordance with a detected motion between the plurality of pictures and generates one camera-shake-corrected picture.

11. The electronic apparatus according to claim 3, wherein the imager unit continuously images a plurality of pictures, and
the electronic apparatus further comprises a camera shake corrector unit which combines a plurality of pictures in accordance with a detected motion between the plurality of pictures and generates one camera-shake-corrected picture.

12. The electronic apparatus according to claim 4, wherein the imager unit continuously images a plurality of pictures, and
the electronic apparatus further comprises a camera shake corrector unit which combines a plurality of pictures in accordance with a detected motion between the plurality of pictures and generates one camera-shake-corrected picture.

13. The electronic apparatus according to claim 1, further comprising a display which indicates that the brightness of the imaged picture is corrected, when the corrector unit has corrected the data of the imaged picture.

14. The electronic apparatus according to claim 1, further comprising a memory area for storing the imaged picture and a memory area for storing data of the picture which has the corrected brightness.

15. An electronic apparatus comprising:
an imager unit which images a picture;
a brightness correction determiner unit which obtains, from the imager unit, data of the imaged picture and an imaging condition of the imager unit applied to the picture, compares the obtained imaging condition with a threshold, and determines whether or not to correct brightness of the data of the imaged picture; and
a corrector unit which corrects, in response to the determination by the determiner unit to correct the brightness, the data of the imaged picture so that the brightness of the imaged picture is increased in accordance with a brightness correction function.
